(19) United States
(12) Patent Application Publication
(10) Pub. No.: US 2017/0101271 A1
(43) Pub. Date: Apr. 13, 2017

(54) ADJUSTABLE FLOOR SLATS FOR RECIPROCATING CONVEYOR

(71) Applicant: Keith Manufacturing Co., Madras, OR (US)

(72) Inventors: John Cook, Madras, OR (US); Daniel Jackson, Madras, OR (US); Randall Mark Foster, Madras, OR (US)

(73) Assignee: Keith Manufacturing Co., Madras, OR (US)

(21) Appl. No.: 15/288,995

(22) Filed: Oct. 7, 2016

Related U.S. Application Data
(60) Provisional application No. 62/239,679, filed on Oct. 9, 2015.

(51) Int. Cl. B65G 25/06

(52) U.S. Cl. CPC B65G 25/065

(57) ABSTRACT

Side-by-side reciprocating floor slats have side wings that provide lateral supports. The upper side wings on one slat rest on bearing surfaces on the side wings of underlying slats. The upper wings have beads that create grooves in the bearing surfaces for the purpose of establishing lateral spacing between slats.

### TECHNICAL FIELD

This disclosure relates to reciprocating floor slat conveyors. More particularly, the disclosure relates to a means for adjusting a reciprocating floor slat conveyor to trailers having variable widths.

### BACKGROUND OF THE INVENTION

Reciprocating floor slat conveyors are well-known. Briefly, these types of conveyor systems involve reciprocating floor slats that are built into the floor of a trailer or the like.

The reciprocating floor slats are driven in one direction, all at the same time, and return in the opposite direction in increments. Typically, one-third of the slats are returned, in three different stages.

Reciprocating floor slat systems are used to haul bulk loads that are inched off the back end of the trailer. When all the slats are moved in unison (toward the trailer's end), the entire load is inched in that direction. By returning a lesser number of slats in the opposite direction, the frictional forces between slat and load are insufficient to move the load backward. Therefore, repetitive cycling of slat reciprocation in the manner just described causes the load to be moved out of the trailer.

Reciprocating floor slat conveyors are generally sold for use in conventional trailers with a drive unit that is designed for a fixed number of floor slats that will be positioned side-by-side across the width of the trailer. The number of slats is generally fixed according to the design of the hydraulic drive unit that reciprocates the slats back and forth. However, trailer widths can be a variable.

The present design allows slats to be installed in a trailer and then self-adjust to variations in trailer width.

### SUMMARY OF THE INVENTION

The improvement disclosed here involves reciprocating floor slats that are designed to be used in a reciprocating floor slat conveyor.

The improvement includes a first reciprocating floor slat that has laterally extending side wings. Each side wing presents an upwardly facing support surface for supporting a reciprocating floor slat on each side of the first one. The side wings are covered by bearings. The material that makes up the bearing is characterized in that it has a certain level of softness. As a non-limiting example, the bearing material may be made of a softer version of plastic such as HMW (see explanation below).

A second reciprocating floor slat is adjacent to the first one just described, although, as explained above, there would be a second reciprocating floor slat on each lateral side of the first one. The second reciprocating floor slat has its own set of laterally extending side wings. Each side wing of the second slat presents a downwardly facing support surface that overlaps and rides on the bearing material that covers one of the upwardly facing support surfaces of the first reciprocating floor slat.

The second reciprocating floor slat is movable relative to the first one. The downwardly facing support surfaces on the second reciprocating floor slat include a portion with a downwardly projecting bead that is shaped to a point. The bead normally rides on the bearing material below. As the second slat moves relative to the first, the bead is shaped to form a groove in the bearing material, which establishes a lateral position of the second reciprocating floor slat relative to the first.

When the above is installed as a part of conveyor floor slat system that extends from one side wall of a trailer to the other, it creates a system of alternating floor slats, with one slat having wings that supports two floor slats on each side, across the width of the trailer—the exception being the side most slats adjacent to the trailer's side walls.

When the slats are initially installed, the beads on the upper slats ride on the bearings below and quickly “groove-in” to the bearing material, thus establishing and fixing the lateral position of the slats relative to each other. By having sufficient lateral length of the various side wings described above, the collection of slats can be adjusted to span a slightly greater or lesser side-to-side width between the trailer side walls.

The foregoing and other features will be better understood upon review of the drawings and description that follows.

### BRIEF DESCRIPTION OF THE DRAWINGS

In the drawings, like reference numerals and letters refer to like elements across the various views, and wherein:

FIG. 1 is a pictorial representation of the improved floor slat system;

FIG. 2 is a frontal perspective view of the floor slat system;

FIG. 3 is another perspective view of the floor slat system;

FIG. 4 is a view similar to FIG. 2, but from a different perspective;

FIG. 5 is a frontal view showing the cross section of one of the slat members (an upper slat member);

FIG. 6 is a frontal view showing the cross section of another one of the slat members (a lower slat member);

FIG. 7 is a view like FIG. 6, but shows a J-bearing on the right-hand side of the lower slat member, but no J-bearing on the left-hand side;

FIG. 8 is a cross section that shows the left-hand side of the lower slat member illustrated in FIG. 7, but with the J-bearing on the left-hand side, and also shows the right-hand side of the upper slat member illustrated in FIG. 5, with a sharpened edge bead riding on the J-bearing;

FIG. 9 is an enlarged cross-sectional view of the sharpened edge bead riding on the J-bearing shown in FIG. 8;

FIG. 10 is an end view of the floor slat system, showing how the upper and lower slat members are mechanically supported in a trailer; and

FIG. 11 is an end view of the floor slat system, like FIG. 10, but shows the system installed within a trailer.

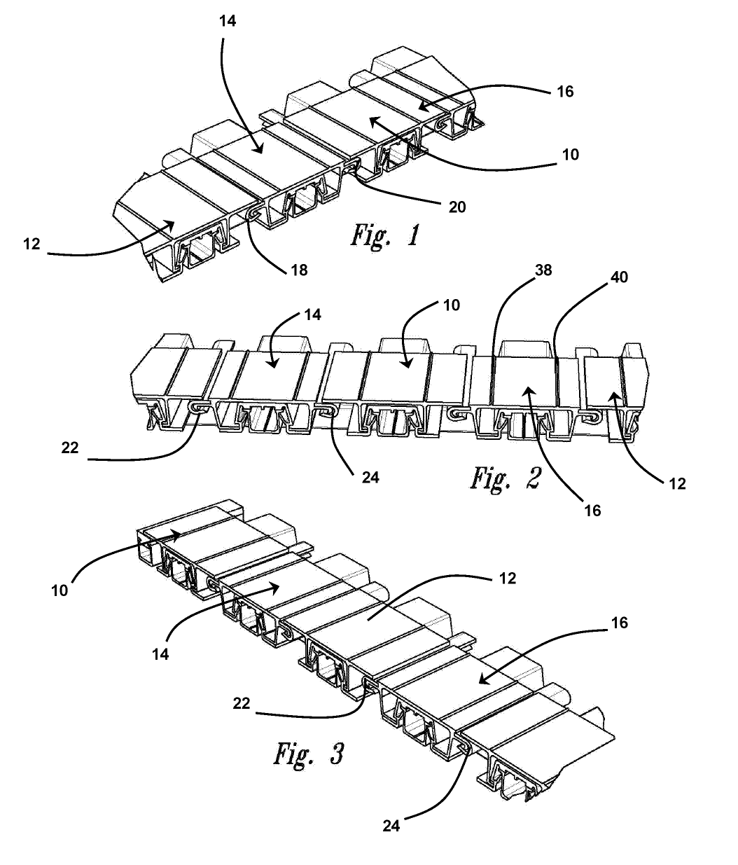

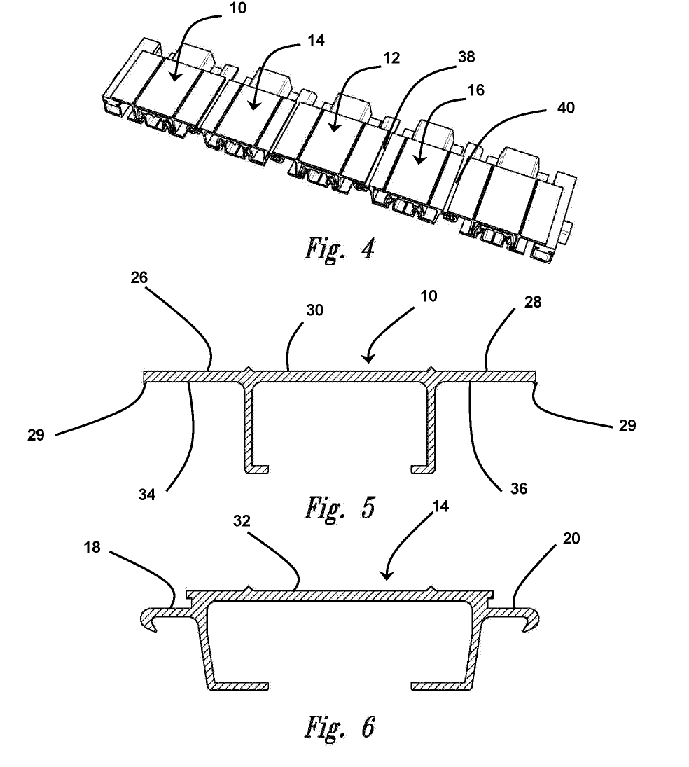

### DETAILED DESCRIPTION

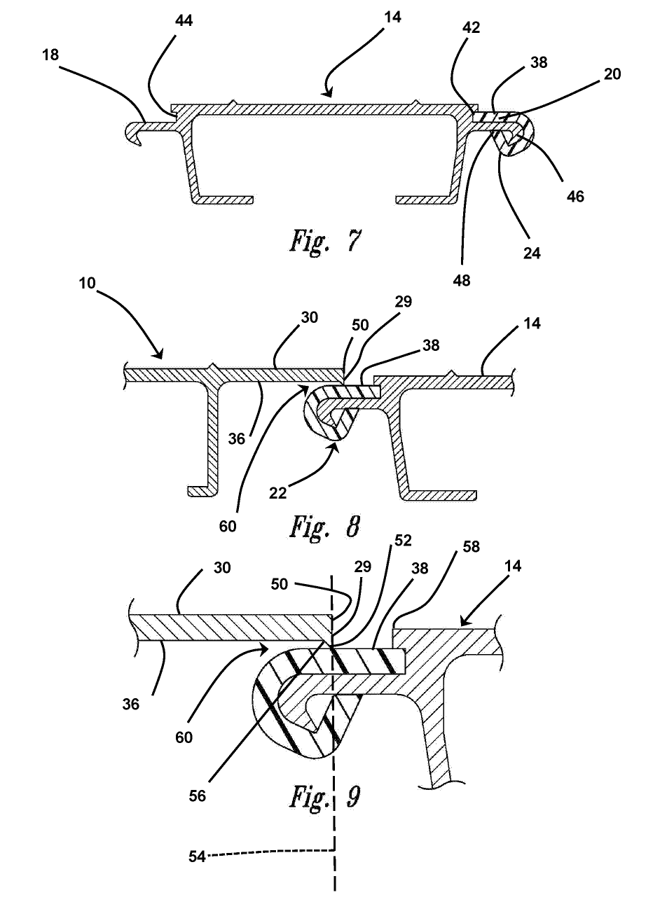

Referring first to FIG. 1, the floor slat system is made up of alternating “upper” and “lower” reciprocating floor slats. The terms “upper” and “lower” are used because the load-supporting surface of one is slightly higher relative to the other. The upper slats are illustrated in FIG. 5 (arrow 10) and are also indicated, generally, by arrows 10 and 12 in the figures. The lower slats are illustrated in FIGS. 6 and 7 (arrow 14) and are generally indicated by arrows 14 and 16 in the other figures.

The lower slats 14, 16 (refer to arrow 14 in FIGS. 6 and 7) have outwardly extending protrusions or wings 18 and 20. These wings 18, 20 hold lateral J-bearings on each side, as indicated at 22, 24, in FIGS. 1, 7, 8, and 9, respectively. The J-bearings 22, 24 are made of nylon or another suitable material (see description about materials set forth below).

The upper slats 10, 12 also have side wings 26, 28 (See FIG. 5) that override or overlap the side wings 18, 20 on the lower slats, one on each side. Each upper slat side wing 26, 28 has a sharpened edge bead 29 that protrudes downwardly. The edge bead 29 rides on the top surface of one of the J-bearings 22, 24, carried by the lower slats 14, 16. These structural features are further described below.

It is anticipated that the upper and lower slats will collectively reciprocate in a typical floor conveyor sequence, such as, for example, all of the slats moving together at the same time, in one direction, and then retracting, one-third of the slats at a time, in the other direction. This reciprocating mode of operation serves to inch a load along the length of the floor, which is well-known in the art.

Reciprocating floor slat systems are often built into the floor of a semi-trailer. However, trailer widths are a variable in that the width between trailer sidewalls is not a precisely uniform width from one trailer to the next. An advantage to the design disclosed here is that it is possible to build a 21-slat system (as a representative number of slats) and adapt that system to typical variations in trailer widths. The top surfaces of the J-bearings 22, 24 provide a variable landing area with a flat supporting surface for the edge beads 29 on the upper slat members 10, 12.

In other words, the lateral width of the J-bearings 22, 24 defines a sufficient bead-supporting surface that allows the lateral spacing of the collection of slats 14, 16, 20, 22 to be expanded or contracted, relative to each other, for the purpose of adapting to wider or narrower distances between a trailer's sidewalls when the system is installed. In this manner, they enable standardized floor slat kits to be sold, with the same number of reciprocating slats, but adaptable to different trailers because they allow width adjustments between individual slats.

Related to the above, and referring to FIGS. 7-9, in the initial installation, the edge beads 29 on the upper slats 10, 12 ride on the J-bearings, located according to initial slat position that is dictated by trailer width. The top surfaces (arrow 30) of the upper slats 10, 12 are elevated relative to the top surfaces (arrow 32) of the lower slats 14, 16. As the slats reciprocate, the edge beads 29 quickly wear a groove (see description regarding FIG. 9 below) into the upper surfaces of the J-bearings (see item 38 in FIG. 9).

The sharpened edge 29 will automatically “groove in” the underlying bearing for a precise fit, and the groove will hold the sharpened edge 29 in place. That is, referring to the reference numbers in the Figs., item 29 makes a groove in items 22, 24. Once again, the initial locating point for the groove is a variable, depending on the actual lateral spacing of the slat system, which is likewise dependent on the width of the trailer installation. However, the “groove in” effect does not commence until the installed slats begin reciprocating.

At initial slat installation, and before significant groove wear is created, there will be a space or gap between the lower surfaces (arrows 34, 36 in FIG. 5) of the wings 26, 28 on the upper slats and the upper J-bearing surfaces (arrows 38, 40 in FIG. 1) on the wings 18, 20 of the lower slats. This gap becomes reduced or quickly disappears when the floor slat system begins to operate, thus increasing the area of sliding surface contact between the wings 26, 28 of the upper members 10, 12 and the J-bearings 22, 24.

Directing attention now to FIG. 7, this figure is similar to FIG. 6, but illustrates a J-bearing on the right-hand wing 20. The left-hand wing 18 is shown without the J-bearing, in order to better describe the physical structures of the wings 18, 20 relative to the lower slat 14. Reference numeral 24 is used in FIG. 7 to designate the J-bearing, consistent with the other figures.

As can be seen in FIG. 7, the inner end 42 of the J-bearing 24 fits within a notch 44 that runs lengthwise of the slat 14, above both of the lateral wings 18, 20. The wings 18, 20 are substantially horizontal and thereby cause the upper surface 38 of each J-bearing to likewise provide a substantial horizontal supporting surface for the sharpened edge bead 29 described above (on the upper slat). The J-bearing 24 wraps around a hook-shaped portion 46 of the slat that also runs along each lateral edge of wings 18, 20. The hook-shaped portion 46 help to hold the J-bearing 24 in place.

Although the J-bearings 22, 24 will be made of a durable material, they will be sufficiently flexible so that the inner end 48 of the J-bearing (refer to FIG. 7) can be opened sufficiently to clip the J-bearing 24 onto the side wing 20 (during installation) or removed in those situations where the J-bearing needs to be replaced due to wear.

The groove arrangement described above helps to seal the arrangement of slats relative to areas below the reciprocating floor system. To the extent material might work its way downwardly, in between side-by-side reciprocating slats, the slat design illustrated in the drawings is suited for allowing the material to work its way through the conveyor system and drop to areas below.

The above design is different from prior designs. The J-bearings 22, 24 described above move with the reciprocating slats. When laterally supporting bearings have been used in the past, they often rest on fixed slats and bearing structures that do not move, letting reciprocating floor slat members ride, back-and-forth, on fixed bearings. Because the J-bearing arrangement 22, 24 described here is intended to move with their respective lower slats 14, 16, they provide additional friction-creating surfaces that move material and provide better clean out.

Other aspects of the design are illustrated in FIGS. 8 and 9. FIG. 8 illustrates one of the upper slats 10 with the sharpened edge bead 29 resting on the upper surface 38 of the left-hand J-bearing 22.

Referring now to FIG. 9, the outer edge 50 of upper slat 10 is flat (shown as substantially vertical from the upper slat's top surface 30 to the underneath surface 36). This allows the edge bead 29 to be extruded as a sharp point 52 on each edge of the upper slat members 10, 12. Having an edge bead 29 configured as a sharpened point facilitates the “grooving-in” effect previously described. In FIG. 9, the groove will be created at the location indicated by dashed line 54.

Compared to the prior art that is known, there have been past designs that use slat edge beads, riding on a seal strip, to create seals between slats in a reciprocating slat system. Different past configurations are described and illustrated in U.S. Pat. No. 5,806,660 (“the '660 patent”), for example. However, the bead designs in the slat extrusions illustrated in the figures of the '660 patent are not of a type such that sharp-point beads can result from the extrusions. In other words, the prior art beads are blunted or even flattened relative to the underlying seal material.

The prior designs have commonly been referred to as “pressure seal” design. The beads on the prior pressure seal designs will slowly wear into the underlying seal material. However, the amount of downward wear is limited or constrained by either blunting the point (see, e.g., beads B′ or B″ in FIGS. 7 and 8 of the '660 patent) or supporting the upper slat from below to prevent a sharp edge bead from wearing too far downwardly into the underlying seal material (see, e.g., item W in FIG. 9 of the '660 patent—which supports the foot 122 of the upper slat 106).

In the present design, the edge bead 29, sharpened to a point, provides the only contact point when the slat system is initially installed. In order to make a sharp bead from a slat that is manufactured via an extrusion process, the edge surface 50 (see FIGS. 8 and 9) on the upper slats 10, 12 needs to be flat, to create an inward bevel 56 (see FIG. 9). The type of extrusions illustrated in the '660 patent are not amenable to extruding “as sharp” edge beads.

Prior art pressure seal systems are commonly designed to use ultra-high molecular weight (“UHMW”) plastics for the underlying seal material (see, e.g., item 114 in FIG. 9 of the '660 patent). The J-bearings 22, 24 in the present disclosure are intended to be made of high molecular weight (“HMW”) plastic. A person skilled in the art would immediately recognize there is a distinction between UHMW and HMW in that UHMW is significantly harder than HMW. The use of softer HMW plastic in the J-bearings 22, 24 disclosed here is what causes the sharpened edge bead 29 to immediately “groove-in.”

Referring to FIG. 9, for example, arrow 54 indicates the location where a groove will be created, quickly, and serve as a track that stabilizes the longitudinal path, or slat alignment, and fixes the lateral spacing of edge surface 50 (on the upper slat 10) relative to edge surface 58 (on the lower slat 14). As can be seen, the distance between edge surface 50 and edge surface 56 is a variable at the time of installation (depends on the trailer width), but becomes fixed as soon as the floor begins to operate.

As mentioned above, prior art pressure seal systems allow for slow wear of edge beads into underlying bearing surfaces. Having a quick “groove-in” effect puts the underneath surface 36 of the upper slat 10 much closer to the top surface 38 of the J-bearing, very quickly. In other words, it results, quickly, in a very small gap in the space generally indicated by arrow 60 in FIGS. 8 and 9. When high loads are placed on the upper slats 10, 12 (e.g., a forklift being driven over the reciprocating floor slat system), the upper slats 10, 12 will flex sufficiently so that the gap 60 (exaggerated in FIGS. 8 and 9) closes with the extra loading. This increases the surface contact area, and thus, the load supporting area for the upper slats 10, 12. The net effect is that it enables the extruded slats to be built with less material (i.e., less aluminum) and still function effectively to both carry normal loads and be driven over by heavy forklifts, if necessary.

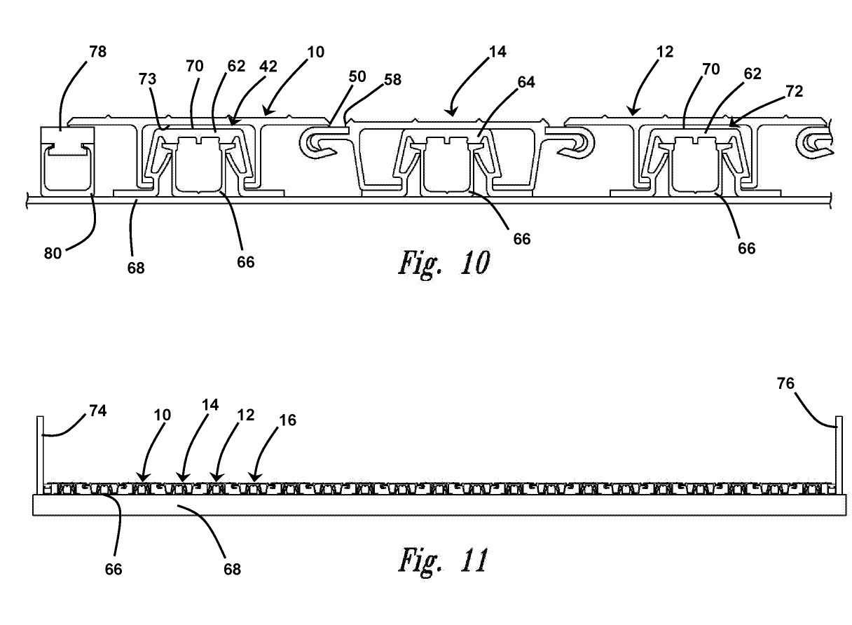

Concerning the above, attention is now directed to FIG. 10. FIG. 10 shows how the upper and lower slats 10, 12, 14, 16 are supported by bearings 62 (for the upper slats) and 64 (for the lower slats). The bearings 62, 64 are fit onto lengthwise beams 66 that are supported by cross-wise structure 68.

High loads on the upper slats 10, 12, allow them to flex so that they are centrally supported by the top surfaces 70 of the bearings 62. This increases the surface contact area, and thus, the load supporting area for the upper slats 10, 12. At other times, there may be a small gap 72 between the bottom 73 of the upper slats 10, 12 and the top surfaces 70 of the bearings 62 (see FIG. 10). The net effect is that it enables the extruded slats to be built with less material (i.e., less aluminum) and still function effectively to both carry normal loads and be driven over by heavy forklifts, if necessary.

The foregoing design is also easier to install. It is envisioned that the system can be installed in less time, overall, which saves installation costs. A typical trailer installation is illustrated in FIG. 11 with the trailer sidewalls shown at 74, 76, respectively. The wider spacing enabled by the present design, between the side edges 50, 58 of the upper and lower slats 10, 14 (see e.g., FIG. 10), provides better overall clean-out of the load as it is inched off the floor. Arrows 78, 80 in FIG. 10 respectively refer to a side bearing and support next to the trailer wall.

A reciprocating floor system that uses the foregoing slat design is likely to be used to haul agricultural and forest products (sawdust, silage, etc.), although it may have other applications. Hauling gypsum products is a problem for reciprocating floor designs because of the fine powder created by gypsum. The design described here provides a better seal for this type of load. But even if the load product works its way past the sealing action caused by the groove, it can still work its way through the floor.

The notch 44 that retains the inner end 42 of the J-bearings (see FIG. 7) is also important to the design because it helps seal the floor by keeping the J-bearing in position against loading forces. The notch also helps to reduce bearing distortion caused by loading forces.

The foregoing sets forth embodiments of the invention that are not intended to limit the scope of patent protection. The scope of patent protection is intended to be limited by the patent claims that follow, the interpretation of which is to be made in accordance with the established doctrines of patent claim interpretation.

What is claimed is:

1. Reciprocating floor slats for use in a reciprocating floor slat conveyor, comprising:
a first reciprocating floor slat having at least one laterally extending side wing, with said side wing presenting an upwardly facing support surface that is covered by a bearing material, with said bearing material being characterized in that said bearing material has a certain level of softness;
a second reciprocating floor slat that is adjacent to said first reciprocating floor slat, with said second reciprocating floor slat having at least one laterally extending side wing, and with said side wing of said second floor slat presenting a downwardly facing support surface that overlaps said bearing material that covers said upwardly facing support surface of said first reciprocating floor slat; and wherein
said second reciprocating floor slat is moveable relative to said first reciprocating floor slat, with said downwardly facing support surface of said second reciprocating floor slat including a portion with a downwardly projecting, pointed bead, and wherein said bead normally rides on said bearing material, said bead being shaped to form a groove in said bearing material as said first reciprocating floor slat moves relative to said second reciprocating floor slat, to thereby establish a lateral position of said second reciprocating floor slat relative to said first reciprocating floor slat.
